(19) United States
(12) Patent Application Publication
(10) Pub. No.: US 2020/0271439 A1
(43) Pub. Date: Aug. 27, 2020

(54) INTEGRATED BEAD MEASUREMENT SYSTEM AND RELATED METHOD

(71) Applicant: Bartell Machinery Systems, L.L.C., Rome, NY (US)

(72) Inventors: Paul David Gatley, Halland Patent, NY (US); Kevin Richard Razy, Lee Center, NY (US); John Robert Russo, II, Marcy, NY (US)

(73) Assignee: Bartell Machinery Systems, L.L.C., Rome, NY (US)

(21) Appl. No.: 16/800,050

(22) Filed: Feb. 25, 2020

Related U.S. Application Data
(60) Provisional application No. 62/810,264, filed on Feb. 25, 2019.

(51) Int. Cl. G01B 11/24; G01B 5/04

(52) U.S. Cl. CPC G01B 11/24; G01B 5/046

(57) ABSTRACT

In one aspect, the present disclosure relates to a bead measurement system with a set of radially-movable support arms for engaging a bead, where the support arms are rotatable such that they are capable of rotating the bead about a central. The bead measurement system may further include a first measurement device, where in an operational state, the first measurement device faces one of an inner profile surface and an outer profile surface of the bead. The bead measurement system may be configured to collect a set of profile measurements based on readings of the first measurement device as the support arms rotate the bead.

### RELATED APPLICATIONS

This application claims the benefit of U.S. Provisional Application No. 62/810,264, filed Feb. 25, 2019, which is hereby incorporated by reference in its entirety.

### BACKGROUND

A vehicle tire generally has two annular bead rings at the innermost diameter, which provide the tire with hoop strength and structural integrity. The beads also provide stiffness at the point where the tire mounts to a rim. Beads are generally manufactured by winding metal wire in a groove on the outer periphery of a chuck or drum, often called a former. A bead may also be formed from a single wire.

Often, a single manufacturing facility may produce several types of beads with varying sizes and shapes. Several parameters of the beads are generally measured after the manufacturing process for purposes of quality control to ensure a high-quality final product. For example, certain parameters of the beads often must fall within a tolerance of 0.005 inches to meet the established quality standards. Parameters that are typically measured may include the inner diameter, height, width, and weight of the tire bead. Typically, measurement devices for measuring such parameters can handle one bead at a time and must be manually loaded. Thus, to enhance efficiency, not all beads are measured, but rather samples are taken from batches of beads.

While sampling has been used with success, measuring all beads may catch beads that are out of tolerance that would otherwise end up in the hands of a consumer. The present disclosure teaches an integrated bead measurement system and related method that improves speed and efficiency of bead measurement, making the measurement of all beads in a particular batch feasible in a manufacturing setting.

### BRIEF DESCRIPTION

In one aspect, the present disclosure relates to a bead measurement system with a set of radially-movable support arms for engaging a bead, where the support arms are rotatable such that they are capable of rotating the bead about a central. The bead measurement system may further include a first measurement device, where in an operational state, the first measurement device faces one of an inner profile surface and an outer profile surface of the bead. The bead measurement system may be configured to collect a set of profile measurements based on readings of the first measurement device as the support arms rotate the bead.

In another aspect, a bead measurement system may include a set of radially-movable support arms for engaging a plurality of beads, where the support arms are coupled to a base, and where the base is rotatable to cause rotation of the support arms about a central axis of the plurality of beads. A first measurement device may be included, where in an operational state, the first measurement device faces a surface of at least one bead of the plurality of beads, and where the base is movable axially to index the first measurement device from a first position to a second position.

In another aspect, a bead measurement system may include a set support arms for engaging a bead, where the support arms are rotatable such that they are capable of rotating the bead about a central axis. A first measurement device may be included, where in an operational state, the first measurement device faces an inner profile surface of the bead to collect measurement data of the inner profile surface as the bead rotates. A second measurement device may also be included, where in the operational state, the second measurement device faces an outer profile surface of the bead to collect measurement data of the inner profile surface as the bead rotates.

### BRIEF DESCRIPTION OF THE DRAWINGS

FIG. 1 is an illustration showing a perspective view of a portion of a bead measurement system in accordance with the present disclosure.

FIG. 2 is an illustration showing a perspective view of a portion of a bead measurement system in accordance with the present disclosure.

FIG. 3 is an illustration showing a side section view of the bead measurement system shown in FIG. 2.

FIG. 4 is a diagram depicting relative dimensions of different-sides beads, and their respective positions in a bead measurement device, in accordance with the present disclosure.

FIG. 5 is an illustration showing a bead measurement device having a robotic arm in accordance with certain aspects of the present disclosure.

FIG. 6 is an illustration showing the bead measurement device of FIG. 5 where the robotic arm is in a second position.

FIG. 7 is an illustration showing the bead measurement device of FIG. 5 where the robotic arm is in a third position.

### DETAILED DESCRIPTION

The present embodiments are described with reference to the drawings in which like elements are referred to by like numerals. The relationship and functioning of the various elements of this invention are better understood from the following detailed description. However, the embodiments of the invention are not limited to the embodiments illustrated in the drawings. It should be understood that in certain instances, details have been omitted which are not necessary for an understanding of the present invention, such as conventional fabrication and assembly.

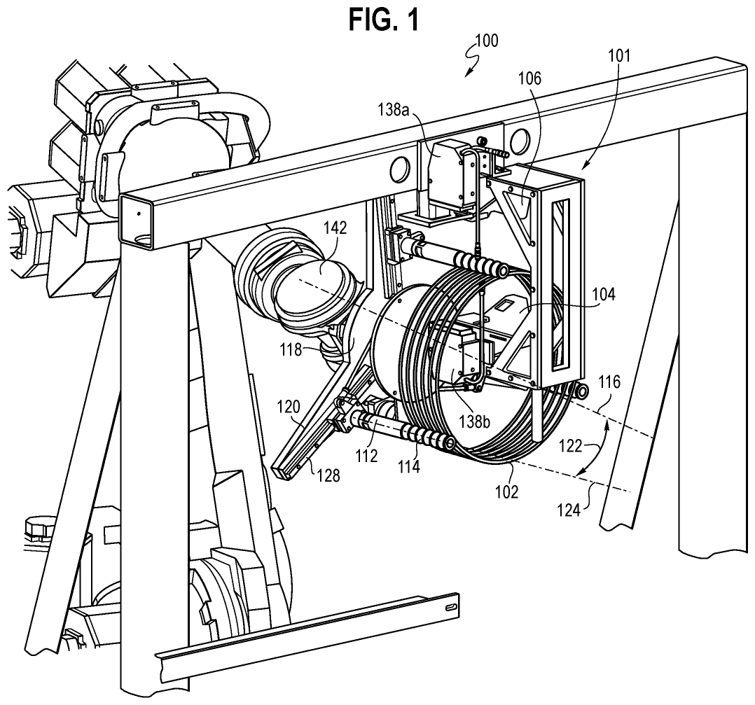

FIG. 1 shows an example of a bead measurement system 100 for measuring one or more dimensions of circular component(s), such as more tire beads 102. While the present embodiments may apply to any other circular component(s), the bead measurement system 100 is described only as measuring tire beads 102 in this disclosure for purposes of illustration. As described in more detail below, the bead measurement system 100 may obtain a collection of measurements by rotating the beads 102 within a measurement assembly 101 such that the beads 102 pass by at least one measurement device as the system collects (and records) measurements, such as dimensions of the bead profile (e.g., inner and/or outer diameter dimensions). For example, in the depicted embodiment, a first measurement device 104 may collect measurements corresponding to an inner diameter surface of the beads 102 and a second measurement device 106 may collect measurements corresponding to an outer diameter surface of the beads 102. Additional measurement devices (e.g., micrometers, weighing devices, etc.) may be included for obtaining other measurements, for redundancy, and/or for verifying accuracy.

As shown in FIG. 1, the bead measurement system 100 may include a set of radially-movable support arms 112 that engage and support the beads 102. The support arms 112 may additionally move the beads 102 to a location within the proximity of the measurement devices 104, 106 for measurement. While three support arms 112 are shown, a different number of support arms (and/or other bead-engaging devices) may be included in other embodiments. Optionally, the support arms 112 may include recesses or grooves 114 configured (e.g., sized and shaped) to each receive an individual bead 102. In the depicted non-limiting example, each of the support arms 112 includes six grooves 114 for receiving six respective beads 102.

The support arms 112 may be movable to rotate the beads 102 about a central axis 116, which is defined through the center point of the circular beads 102. For example, the support arms 112 may be coupled to a rotatable base 118. Optionally, each of the support arms 112 be coupled to one of three base protrusions 120 (e.g., one for each support arm 112). When the base 118 rotates about the axis 116, the support arms 112 rotate with it, which also causes the beads 102 to rotate (e.g., in the direction 122). In this embodiment, the beads 102 may be firmly held by the support arms 112 such when the support arms 112 rotate, the beads 102 rotate the same amount.

In certain alternative embodiments, the base 118 may be fixed (when measuring) and the support arms 112 may rotate about their own central axis, depicted as second axes 124. In these embodiments, the rotation of at least one of the support arms 112 may be driven (e.g., via a motor or other rotation-causing actuator), thereby causing the beads 102 to rotate about the axis 116 without translational movement of the support arms 112. The other support arms 112 may be idlers (and thus driven by the beads 102 themselves).

Referring to the embodiment of FIG. 1, to facilitate loading and unloading of the beads 102, the support arms 112 may be movable radially. For example, the support arms 112 may be coupled to the protrusions 120 of the base 118 via a set of tracks or slots 128. Each support arm 112 may be linearly slidable along the tracks or slots 128, which creates the radial movement relative to the central axis of the beads 102. This radial movement of the support arms 112 may be controlled by an actuator (e.g., a programmed or manually-actuatable linear actuator coupled to the base 118), or it may be manually-controlled (e.g., requiring manual intervention from a user). The support arms 112 may be mechanically coupled to one-another such that a single actuator moves them all the same amount, which may decrease the complexity and cost of the system relative to other embodiments. In certain exemplary embodiments, the ability of the support arms 112 to move radially allows the bead measurement system 100 to accommodate beads of different sizes. Any bead (or other component) of any size may be engaged, such as beads with diameters of as little as 6 inches (or less) to as great as 100 inches (or more), or anywhere in-between. Other types of components may fall well outside of this range (perhaps requiring different-sized mechanical components), but the principles described herein are not limited to objects within any size range.

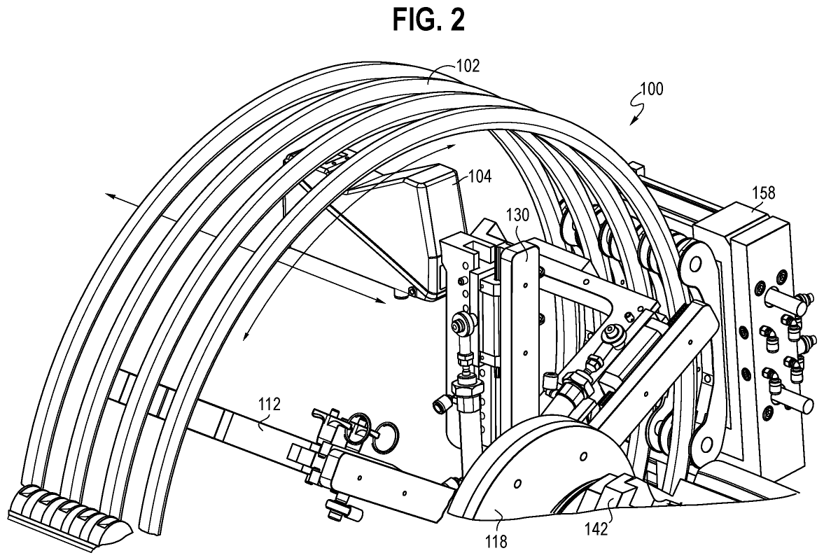

FIG. 2 shows an embodiment of the bead measurement system 100 similar to that of FIG. 1, but having the support arms 112 configured such that they engage an inner diameter surface of the beads 102 (rather than an outer diameter surface as shown in FIG. 1). Thus, while not shown, the support arms 112 may have grooves or other structures configured to receive and engage the inner surface of the beads 102. Like the embodiment of FIG. 1, the support arms 112 of FIG. 2 may be movable radially such that when such that they can move into and out of engagement with the beads 102 (e.g., during loading and unloading), and/or can accommodate beads of different sizes. Optionally, the measurement device 104 may be coupled to the base 118. However, the measurement device 104 may remain fixed in position when the support arms 112 rotated, or vice versa, such that it can collect an entire set of measurements around the full circumference of the beads 102. Alternatively, it is contemplated that the measurement device 104 may rotate prior to engagement between the support arms 112 and the beads 102 such that measurements occur when the beads 102 are supported by another object (e.g., the unloader 158, described in more detail below), and notably the support arms 112 may be unnecessary in such embodiments.

In the embodiment of FIG. 2, the measurement device 104 may be movable radially by the bead measurement system 100 in a manner similar to the above-described radial movability of the support arms 112. For example, the system may radially move the measurement device 104 to a proper position for an accurate profile measurement. A frame member 130, which may be fixed to the measurement device 104, may be movable relative to the base 118 in a manner similar to the support arms 112. It is contemplated that the frame member 13 may be mechanically coupled to the support arms 112 such that when the support arms 112 move radially, the first measurement device 104 moves with them the same amount. When this is the case, the first measurement device 104 may have a position that is precisely calibrated relative to the support arms 112 such that the first measurement device 104 is in a proper position for measuring whenever the support arms 112 are engaged with the beads 102 (which is advantageous for self-adaptation to multiple bead sizes).

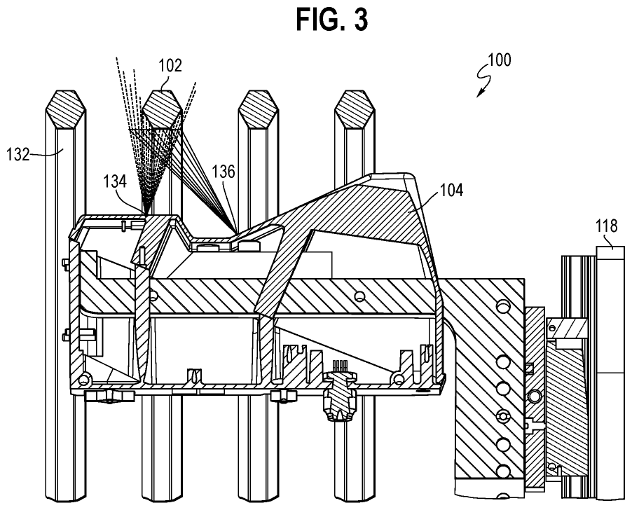

FIG. 3 depicts a side view of the operation of the measurement device 104. As shown, when the beads 102 rotate about their central axis 116, an inner diameter surface 132 may pass by the measurement device 104. The measurement device 104 may be a non-contact measurement device, such as a device having a camera and/or laser capable of determining, with high accuracy and precision, the distance to the inner diameter surface of the beads 102 relative to a sensor of the measurement device 104, which may be converted into a diameter or other profile dimension via calculation. For example, the measurement device 104 may include a laser 134 and a camera 136. The laser 134 may be projected towards the bead 102, and the camera 136 may detect the laser 134. In other embodiments, the measurement device 104 may be another suitable contact-based or non-contact-based measurement device.

Optionally, multiple measurements may be taken at different locations on the inner diameter surface 132 such that the measurement device 104 measures not only the minimum inner diameter, but rather maps the cross-sectional shape of the inner-diameter profile of the beads 102. These multiple measurement values may be collected by a data acquisition system or other suitable device, recorded, and analyzed to ensure the dimensions of the beads 102 meet appropriate quality standards. Portions of data collection, processing, and recordation may be executed in a processor or other electronic device within (or external to) the bead measurement system 100.

In exemplary embodiments, the measurement device 104 may operate continuously as the beads 102 rotate such that the bead measurement system 100 maps substantially the entirety of the inner diameter surface 132 around the entire circumference of the beads 102. When a full revolution is complete, the bead measurement system 100 may have obtained tens, hundreds, or even thousands of discrete measurements, thus providing an extremely high probability of detecting any quality issues.

While the embodiment of FIGS. 2-3 does not include a depicted second measurement device associated with the outer diameter surface of the beads 102, it may include one (similar to the embodiment of FIG. 1). Such a second measurement device (e.g., including that of FIG. 1) may operate in the manner described above, and thus the second measurement device 106 may take (and record) measurements corresponding to the outer diameter surface of the beads 102, thereby mapping the outer diameter and/or another outer-surface dimension.

Referring back to FIG. 1, the bead measurement system 100 may include other types of measurement devices, such as a micrometer 138 (e.g., having an emitter 138a and a receiver 138b). The micrometer 138 may be configured to measure a width of the bead, which may be a dimension of the absolute width in the direction parallel to the central axis 116. The micrometer may be any suitable type of micrometer. Like the measurement devices 104, 106, the micrometer 138 may take a series of measurements as the beads 102 rotate, and such measurements may be recorded to map the width of the beads 102 over a full revolution.

The measurement devices described above may be capable of measuring multiple beads 102 at once. For example, referring only to the first measurement device 104 (for simplicity, though this paragraph may also apply to all other measurement devices), multiple sensors and/or multiple detection means may be included such that the dimensions of multiple adjacent beads 102 are taken and recorded at the same time. For example, all six beads 102 (or even more in other embodiments) may be measured with one measurement device upon one full revolution. In other embodiments, the first measurement device 104 may be capable of measuring less than all of the beads 102 at once (e.g., via a simpler and more cost-effective measurement device). In these situations, the base 118 (and therefore also the support arms 112 and beads 102) may be capable of indexing axially (i.e., in the direction parallel to the central axis 116 of the beads 102). After a full revolution to measure a certain bead 102 (or more than one bead 102 but less than the full set), the system may index to move other beads 102 into position for measurement, and then another rotation may occur. To simplify wiring and/or mechanical components, the rotation may reverse after each revolution. Alternatively (or additionally), the measurement devices may be movable axially, and/or the measurement devices may be otherwise capable of changing which bead they are measuring (e.g., via pointing a camera/sensor in a different direction).

In the depicted embodiments of FIGS. 1-2, axial movement of the beads 102 may be driven by a robotic arm assembly 142 that is coupled to a backside of the base 118. The robotic arm assembly 142 assembly is described in more detail below. Other ways of moving the beads 102 axially may alternatively be included. For example, it is contemplated that the support arms 112 may have telescoping properties such that they have the ability to adjust their lengths (e.g., via a linear actuator, pneumatics, etc.).

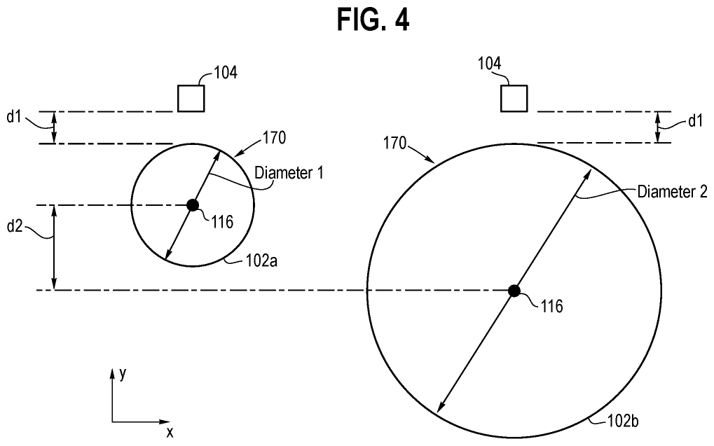

In some embodiments, the base 118 may also be movable in a direction perpendicular to the central axis 116 (i.e., the “y” direction in FIG. 1) to reposition the central axis 116. This may be advantageous for ensuring the measurements remain accurate when different-sized beads 102 are used. To illustrate, and with reference to FIG. 4, the measurement devices 104 often work best when the distance (d1) between the measurement devices 104 and a surface 170 they are measuring falls within a specific narrow range. Thus, the central axis 116 may need to move to accommodate a change in bead size when different beads are loaded onto the bead measurement system 100. To ensure the bead surfaces are in appropriate proximity (d1) to the measurement devices when changing from a smaller bead 102a to a larger bead 102b, the central axis 116 may be moved further away by manipulating the position of the base 118 (shown in FIG. 1). Assuming the measurement device 104 is centered in the x-direction, the distance the axis moves (d2) is equal to the difference in radii (or one half the difference in diameters).

While any suitable device is contemplated to move the base 118 (e.g., linear actuators, hydraulics, manual movement, etc.), the robotic arm assembly 142 provides the base 118 movement in the depicted embodiment of FIGS. 1-2. For example, the robot arm assembly 142 may include a controller that is pre-programmed to move the base 118 into a particular position for a particular bead size. In advanced systems, the robotic arm assembly 142 may be capable of making minor adjustments to the position of the base 118 based on feedback from one or more sensors (e.g., sensors of the measurement devices described above, or other sensors), which may further enhance the accuracy and/or precision of the bead measurement system 100.

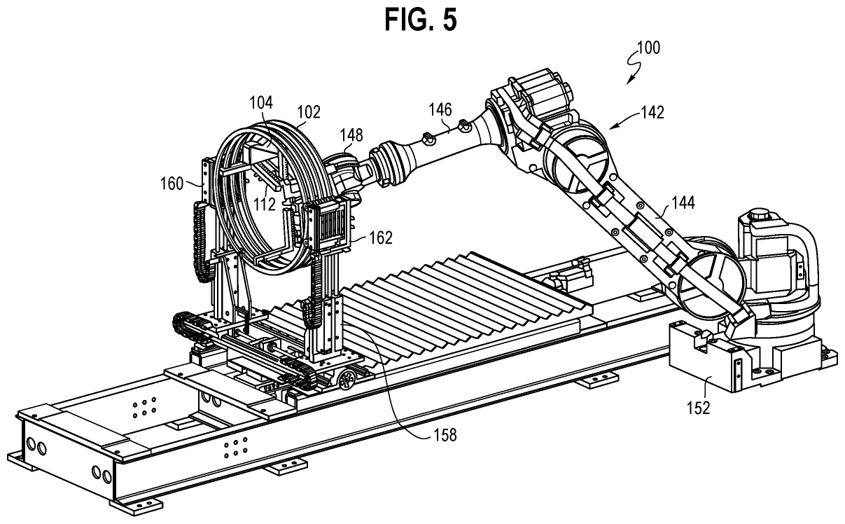

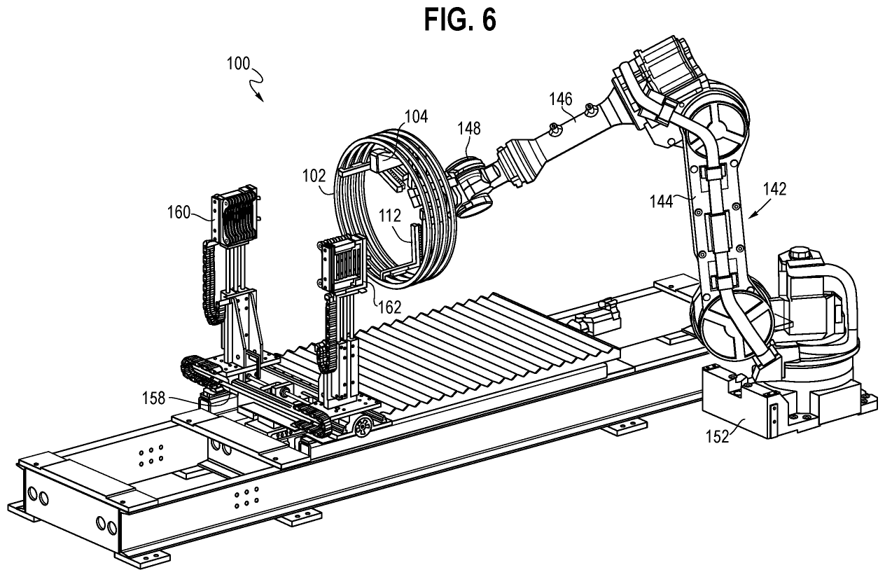

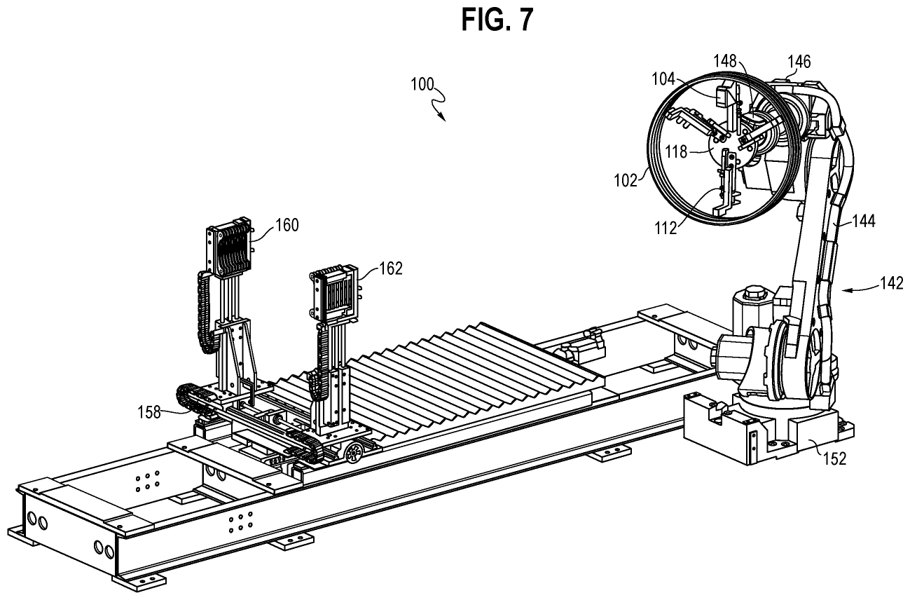

FIGS. 5-7 are illustrations with a larger viewing range that depict an example of the robotic arm assembly 142 (in this case included with the bead measurement embodiment of FIG. 2, but with features applicable to any other suitable embodiment). The robotic arm assembly 142 may include one or more robotic arm segments (e.g., a first arm segment 144, a second arm segment 146, and a third arm segment 148). The robotic arm segments may be movable relative to one another via any suitable means (e.g., hydraulics, electric actuators, etc.). For example, the first arm segment 144 may be connected to a base or foot 152 (in this case with the capability of rotating with two degrees of freedom), the second arm segment 146 may be connected to an end of the first arm segment 144 (e.g., with one or more degrees of freedom), and the third arm segment 148 may be connected to an end of the second arm segment 146 (e.g., with one or more degrees of freedom). Additional (or less) arm segments may be included in other embodiments.

The robotic arm assembly 142 may be tasked with causing the above-described rotation of the bead 102 (e.g., such that they rotate past a measurement device). In the depicted embodiment, the first arm segment 144 and the second arm segment 146 may have fixed positions while the third arm segment 148 rotates about its longitudinal axis (without linear translation) to cause such rotation. The robotic arm assembly 142 may additionally or alternatively be tasked with indexing the bead measurement system 100 (e.g., by moving at least one of a bead and measurement device linearly along the axes of the beads, as described above). To accomplish the indexing, the second arm segment 146 and/or the first arm segment 144 change their orientations to move the third arm segment 148 in the z-direction while the third arm segment 148 remains a fixed distance from the central axis of the beads 102. In other embodiments, at least one arm segment, such as the third arm segment 148, may have telescoping (or other length-changing) capabilities such that indexing can occur without substantial movement of the second arm segment 146 and/or the first arm segment 144. Any other alternative arrangement of arm segments is contemplated.

The robotic arm assembly 142 may additionally or alternatively be capable of other movements. For example, the robotic arm assembly 142 may be configured to move the bead measurement system 100 into and out of engagement with the beads 102. More particularly, referring to FIG. 5, the robot arm assembly 142 may be capable of removing the beads 102 from an unloader 158 (which may house the beads 102 after their initial formation). It is contemplated that the bead measurement system 100 may measure the beads 102 while they are located on the unloader 158 (e.g., via rotation of a measurement device relative to the beads 102 while they are held in place by the unloader 158), but this is not required. Once removed from the unloader 158, the beads 102 may be taken to another device, such as the measurement assembly 101 (identical or similar to that of FIG. 1), a weigh station (e.g., with a holding device for securing and weighing the beads with individual load cells), a storage device, etc.

In one exemplary measurement method, the robotic arm assembly 142 may collect one or more beads 102 from the unloader 158 after bead formation. Such collection may include engaging the beads 102 on their outer surface (like in FIG. 1) or inner surface (like in FIG. 2) with the movable support arms 112. The unloader 158 may release the beads 102 (e.g. via horizontal movement of the two holding portions 160, 162) when they are engaged by the bead measurement system 100. Optionally, the robotic arm assembly 142 may then move the beads 102 to a weigh station, where it drops the beads 102 off for weighing (and the weighing, if included, may occur at a different step). The robotic arm assembly 142 may then move the beads 102 to the measurement assembly 101 (as shown in FIG. 1), where it precisely locates the beads 102 relative to a measurement device and then rotates the beads 102 to collect a set of measurements. If indexing is required, the robotic arm assembly 142 may move the beads 102 axially between measurements such that all beads 102 are measured. In some embodiments, the bead measurement system 100 may reverse the direction of rotation after each indexing step to reducing the need for excessive wiring. Next, the robotic arm assembly 142 may move the beads 102 back to the unloader 158, a storage area, and packaging area, and/or a downstream manufacturing process. An indicator or ejection means may be included for identifying and/or ejecting a bead that is determined to be out of tolerance in accordance with determined quality standards. Any of these steps may be excluded, and/or additional steps may be included.

The present embodiments provide enhanced speed, precision, and accuracy relative to prior measurement systems, thereby increasing the overall efficiency and success of the quality process. In certain tests performed by the inventors, the outer diameter profile, the inner diameter profile, the weight, and the width of up to eight (8) beads have been measured in less than 15 seconds, which is a substantial improvement over prior systems. In view of the system's speed, it may be capable of measuring parameters of all manufactured beads (or other components) rather than sampling certain bead(s) in a batch (as is presently customary), and therefore the principles of the present embodiments may prevent samples that are out of tolerance from ending up in the hands of consumers.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

We claim:

1. A bead measurement system, comprising:
a set of radially-movable support arms for engaging a bead, wherein the support arms are rotatable such that they are capable of rotating the bead about a central; and
a first measurement device, wherein in an operational state, the first measurement device faces one of an inner profile surface and an outer profile surface of the bead,
wherein the bead measurement system is configured to collect a set of profile measurements based on readings of the first measurement device as the support arms rotate the bead.

2. The bead measurement system of claim 1, wherein the support arms are movable axially to index the bead measurement system for measurement of a second bead.

3. The bead measurement system of claim 1, wherein the first measurement device includes at least one of a laser and a camera.

4. The bead measurement system of claim 1, wherein the support arms are coupled to a base, and wherein the base is movable in at least two directions via a robotic arm.

5. The bead measurement system of claim 1, further comprising a micrometer configured to obtain a width measurement of the bead as the bead is rotated by the support arms.

6. The bead measurement system of claim 5, wherein the micrometer includes an emitter and a receiver, and wherein the emitter and the receiver are fixed relative to the first measurement device.

7. The bead measurement system of claim 1, wherein the first measurement device faces the inner profile surface of the bead, and wherein the bead measurement system further comprises a second measurement device facing the outer profile surface of the bead.

8. A bead measurement system, comprising:
a set of radially-movable support arms for engaging a plurality of beads, wherein the support arms are coupled to a base, and wherein the base is rotatable to cause rotation of the support arms about a central axis of the plurality of beads; and
a first measurement device, wherein in an operational state, the first measurement device faces a surface of at least one bead of the plurality of beads, and
wherein the base is movable axially to index the first measurement device from a first position to a second position.

9. The bead measurement system of claim 8, wherein in the first position, the first measurement device is in position for measuring a first bead of the plurality of beads, and wherein in the second position, the first measurement device is in position for measuring a second bead of the plurality of beads.

10. The bead measurement system of claim 8, wherein the first measurement device includes at least one of a laser and a camera.

11. The bead measurement system of claim 8, wherein the base is movable in a direction perpendicular to the central axis to adjust a position of the central axis relative to the first measurement device.

12. The bead measurement system of claim 8, further comprising a micrometer configured to obtain a width measurement of the bead as the bead is rotated by the support arms.

13. The bead measurement system of claim 12, wherein the micrometer includes an emitter and a receiver, and wherein the emitter and the receiver are fixed relative to the first measurement device.

14. The bead measurement system of claim 8, further comprising a second measurement device, wherein in the operational state, the second measurement device faces a second surface of the at least one bead.

15. A bead measurement system, comprising:
a set support arms for engaging a bead, wherein the support arms are rotatable such that they are capable of rotating the bead about a central axis; and
a first measurement device, wherein in an operational state, the first measurement device faces an inner profile surface of the bead to collect measurement data of the inner profile surface as the bead rotates, and
a second measurement device, wherein in the operational state, the second measurement device faces an outer profile surface of the bead to collect measurement data of the inner profile surface as the bead rotates.

16. The bead measurement system of claim 15, wherein the support arms are movable axially to index the bead measurement system for measurement of a second bead.

17. The bead measurement system of claim 15, wherein the first measurement device includes at least one of a laser and a camera.

18. The bead measurement system of claim 15, wherein the support arms are coupled to a base, and wherein the base is movable in at least two directions via a robotic arm.

19. The bead measurement system of claim 15, further comprising a micrometer configured to obtain a width measurement of the bead as the bead is rotated by the support arms.

20. The bead measurement system of claim 19, wherein the micrometer includes an emitter and a receiver, and wherein the emitter and the receiver are fixed relative to the first measurement device.
